(19) United States
(12) Patent Application Publication
(10) Pub. No.: US 2025/0180109 A1
(43) Pub. Date: Jun. 5, 2025

(54) ARRANGEMENT AND METHOD FOR THE NEEDS-BASED CONTROL OF COOLING/LUBRICATING OIL FLOWS AND THEIR FLOW TEMPERATURES IN AN ELECTRIC TRACTION DRIVE

(71) Applicant: MAGNA Powertrain GmbH & Co KG, Lannach (AT)

(72) Inventors: Christoph GSENGER, Graz (AT); Wolfgang SCHWEIGER, St. Stefan (AT)

(21) Appl. No.: 18/957,967

(22) Filed: Nov. 25, 2024

(30) Foreign Application Priority Data
Dec. 5, 2023 (DE) 102023212249.9

(51) Int. Cl. F16H 57/04

(52) U.S. Cl. CPC F16H 57/0476; F16H 57/0413; F16H 57/0415; F16H 57/0435; F16H 57/0436

(57) ABSTRACT

An arrangement for the needs-based control of the flow temperatures of cooling/lubricating oil flows in an electric traction drive having an electrically controllable motor-pump unit and a hydraulic unit, wherein the motor-pump unit can be controlled in two directions of rotation, namely in a first direction of rotation and in a second direction of rotation which is opposite to the first direction of rotation, and wherein a first pressure level and a second pressure level, which is higher than the first pressure level, can be set at the motor-pump unit by way of the closed-loop control of the rotational speed in the first direction of rotation or the second direction of rotation. The motor-pump unit is connected by way of the hydraulic unit to multiple fluid outlets for a first, a second and a third partial volume flow which are connected for cooling and/or heating and/or lubrication at least to the stator of an electric drive unit, and/or the rotor of the electric drive unit and/or a gearbox, wherein the arrangement comprises a heat exchanger, and the first partial volume flow is not connected to the heat exchanger, and wherein the direction of rotation and the pressure level of the motor-pump unit can be adjusted by way of an electric control unit and three different operating modes can be set depending on the direction of rotation and the pressure level.

### CROSS-REFERENCE TO RELATED APPLICATIONS

This application claims priority to German Application No. DE 102023212249.9 filed Dec. 5, 2023. The entire disclosure of the above application is incorporated herein by reference.

### FIELD OF THE INVENTION

The invention relates to an arrangement and a method for the needs-based control of cooling/lubricating oil flows and their flow temperatures in electric traction drives equipped with an electrically controllable motor-pump unit and a hydraulic arrangement, wherein the motor-pump unit can be controlled in both directions of rotation and wherein the motor-pump unit is connected by way of a heat exchanger to multiple fluid outlets which are connected for cooling and/or heating and/or lubrication at least to the stator of an electric machine, to the rotor of the electric machine and to a gearbox.

### BACKGROUND OF THE INVENTION

This section provides information related to the present disclosure which is not necessarily prior art.

Electric traction drives essentially consist of an electric machine, an inverter and a reduction gear. The maximum power, service life and efficiency of these components are largely determined by the selected cooling concept. The trend towards ever higher power outputs in the same installation space, as well as the increasing integration density, inevitably requires improvements in terms of cooling and heat management.

High-performance electric drive systems with high energy density are generally equipped with an electrically operated oil pump and an oil-water heat exchanger for cooling. Oil pumps driven by brushless DC motors (BLDC motors) are commonly used. The preferred type of pump is a rotary displacement pump in the form of an annular gear pump or gerotor-type pump.

The delivery volume flow provided by the electric oil pump is used primarily for needs-based cooling of the temperature-critical active components (stator and/or rotor) of the electrical machine. The electrically operated oil pump is switched on and off as needed and/or operated at variable rotational speeds.

The cooling and lubrication of the gearbox components is usually passive, wherein the conveying effect of the differential spur gear or an intermediate shaft spur gear is used in combination with a suitable housing that acts as an oil guide. This is associated with a limited conveying effect that is dependent on the vehicle speed and the gear wheel rotational speed, and the associated hydrodynamic losses (splash losses), which are highly dependent on the rotational speed and the oil temperature.

An increase in the overall efficiency of the electric drive system can be achieved by actively supplying the gearbox with a cooling/lubricating oil volume flow provided by the electric oil pump (dry sump lubrication).

The disadvantage of this is that, with an active supply of both the active components (stator and rotor) of the electric machine and the gearbox by means of a cooling/lubricating oil volume flow provided by the electric oil pump, the fluid flow temperature of the cooling/lubricating oil flows flowing into the “gearbox” and “electric machine” subsystems cannot be controlled independently of each other, but are determined by the heat exchanger outflow temperature. Generally, the cooling oil flow temperature for cooling the temperature-critical active components (stator and/or rotor) of the electric drive unit is kept low—for reasons of high thermal availability. On the other hand, the flow temperature of the partial volume flow used to cool and lubricate the components of the reduction gear and differential can be raised to a higher flow temperature to reduce viscous friction losses.

In order to solve this problem, it is known from WO 2023/133 200 A1, in the case of a vehicle drive unit with an electric motor and a gearbox as subcomponents, to provide separate cooling lubricant circuits with correspondingly adapted compositions and properties of the lubricants for the two subsystems. A separate pump, filter and cooler are required for each cooling lubricant circuit.

An arrangement and a method for the needs-based distribution of cooling/lubricating oil flows in the electric traction drive are known from the document DE 10 2022 214 389 A1. The arrangement has a motor-pump unit that is controlled in both directions of rotation. The motor-pump unit is connected by way of a heat exchanger to multiple fluid outlets for partial volume flows, which are connected to the stator of an electric machine, a rotor of an electric machine and the gearbox for cooling, heating and/or lubrication. When the direction of rotation of the motor-pump unit is reversed, a hydraulically switchable valve additionally opens a fluid outlet. The partial volume flows for the electric drive are available by way of the fluid outlets.

DE 10 2011 118 574 A1 discloses a drive train cooling arrangement and a method for operating it. The drive train cooling system has a bidirectional pump assembly driven by a pump electric motor. The pump connections of the bidirectional pump arrangement are each connected to cooling circuits. The through-flow rate of the coolant directed into the cooling circuits is adjusted by changing the rotational speed of the pump electric motor.

### SUMMARY OF THE INVENTION

This section provides a general summary of the disclosure, and is not a comprehensive disclosure of its full scope or all of its features.

The object of the invention is to enable an improved, needs-based provision of the cooling oil flows to the rotor shaft and stator of the electric machine and to the gearbox components, wherein the electric drive system is to be cost-effective with an improved overall efficiency and optimized with respect to the number of components and installation space.

This object is achieved by an arrangement for the needs-based control of the flow temperatures of cooling/lubricating oil flows in the electric traction drive with an electrically controllable motor-pump unit and a hydraulic unit, wherein the motor-pump unit can be controlled in two directions of rotation, namely in a first direction of rotation and in a second direction of rotation which is opposite to the first direction of rotation, and wherein a first pressure level and a second pressure level, which is higher than the first pressure level, can be set at the motor-pump unit by closed-loop control of the rotational speed in the first direction of rotation or the second direction of rotation, and wherein the motor-pump unit is connected by way of the hydraulic unit to multiple fluid outlets for a first, a second and a third partial volume flow which are connected for cooling and/or heating and/or lubrication at least to the stator of an electric drive unit, and/or the rotor of the electric drive unit and/or a gearbox, wherein the arrangement comprises a heat exchanger, and wherein the first partial volume flow is not connected to the heat exchanger, and wherein the direction of rotation and the pressure level of the motor-pump unit can be adjusted by means of an electric control unit and three different operating modes can be set depending on the direction of rotation and the pressure level, wherein the first partial volume flow is assigned to the inflow of the gearbox, the second partial volume flow is assigned to the inflow of the rotor and the third partial volume flow is assigned to the inflow of the stator, and wherein the hydraulic unit has a shuttle valve connected downstream in the flow path of the motor-pump unit and a downstream hydraulically controllable valve, preferably a 3/2 directional control valve, wherein the 3/2 directional control valve is adjustable from a first position into a second position by way of a control line and a control pressure, and wherein in the first position of the 3/2 directional control valve the volume flow is connected from the motor-pump unit by way of a fluid line to the heat exchanger and wherein the outlet of the heat exchanger is designed as a fluid line which branches into the second and third partial volume flows, wherein the third partial volume flow runs directly as an inflow to the stator and wherein the second partial volume flow is fed to the rotor by way of a hydraulically controllable non-return valve.

The arrangement according to the invention for the needs-based control of the cooling/lubricating oil flows in electric traction drives makes it possible to adjust the fluid flow temperatures of the partial volume flows to the gearbox components and to the temperature-critical active components of the electric drive unit (stator and/or rotor) in a simple manner and with few hydraulic components.

The existing motor-pump unit of the system is expanded to include simple and cost-effective hydraulic valves and shut-off valves, enabling bidirectional operation of the pump. This makes it possible to realize different volume flow distributions—firmly defined by way of hydraulic resistance control—in the clockwise and counterclockwise rotation of the pump.

The arrangement according to the invention, which comprises an oil pump which is installed in the gearbox and is connected to a hydraulic unit and has a heat exchanger, allows the lubricating coolant, which is preferably an oil, to be optionally guided as an oil flow through the heat exchanger or conveyed directly into the gearbox or to the temperature-critical active components (stator and/or rotor).

In this way, the most efficient state can always be selected by means of a corresponding operating strategy for the electric oil pump, depending on the vehicle operating mode.

According to the invention, active cooling of temperature-critical active components, which are the stator and/or the rotor of the electric drive unit (electric motor), can take place. Furthermore, active cooling and lubrication of the gearbox is possible, or, in a different operating mode, passive lubrication of the gearbox by splashing.

Non-cooled oil can be conveyed into the gearbox, as this is located on the high-temperature side.

Orifices enable a pre-setting of the partial volume flows.

The hydraulically switchable valve is a hydraulically actuatable 3/2 directional control valve.

The arrangement can be realized in a robust design by using simple hydraulic shut-off valves and an intelligent operating strategy.

In a further development according to the invention, the different operating modes can be implemented by simple non-return valves and spring non-return valves, so that a hydraulically actuatable 3/2 directional control valve can be dispensed with.

In order to achieve different flow temperatures for the gearbox on the high-temperature side and the electric machine with the active components rotor and stator on the low-temperature side, only one motor-pump unit and one heat exchanger are required. This is particularly advantageous in terms of costs and installation space.

The object is also achieved by a method for the needs-based distribution of cooling/lubricating oil flows in the electrical traction drive.

It is advantageous that different operating modes are set to adjust the flow temperatures of the respective partial volume flows at the fluid outlets.

Three different operating modes can be set from the operation of the motor-pump unit in a direction of rotation A or a direction of rotation B at different pressure levels.

The solution according to the invention provides the following advantages:

The invention allows the needs-based control of the flow temperature of partial volume flows to increase the efficiency and/or thermal availability of electric drive systems with fully or partially oil-cooled electric drive units.

The hydraulically controlled valves allow precise control of the partial volume flows without additional electrical energy consumption.

The possibility of software-based adjustment of the partial volume flows provides a high degree of flexibility.

Depending on the operating mode, the desired maximum in terms of efficiency and/or thermal availability can be achieved by combination with intelligent, self-learning functional software.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a schematic representation of the cooling lubricant circuit according to the invention, with an adjustable fluid flow temperature of the partial volume flows to the gearbox and to the temperature-critical active components of the electric drive unit (stator and/or rotor),

FIG. 2 shows a hydraulic circuit diagram of the arrangement according to the invention in a first embodiment with a 3/2 directional control valve,

FIG. 3 shows a hydraulic circuit diagram of the arrangement according to the invention in a second embodiment with two separate oil sumps and a 3/2 directional control valve,

FIG. 4 shows a hydraulic circuit diagram of the arrangement according to the invention in a third embodiment with two separate oil sumps,

FIG. 5 shows a signal flow diagram of the method for the needs-based distribution of cooling/lubricating oil flows in an electric traction drive according to the first embodiment,

FIG. 6 shows the path of the volume flow of the second embodiment in a first realizable operating mode,

FIG. 7 shows the path of the volume flow of the second embodiment in a second realizable operating mode,

FIG. 8 shows the path of the volume flow of the second embodiment in a third realizable operating mode,

FIG. 9 shows the path of the volume flow of the third embodiment in a first realizable operating mode,

FIG. 10 shows the path of the volume flow of the third embodiment in a second realizable operating mode; and

FIG. 11 shows the path of the volume flow of the third embodiment in a third realizable operating mode.

### DESCRIPTION OF THE INVENTION

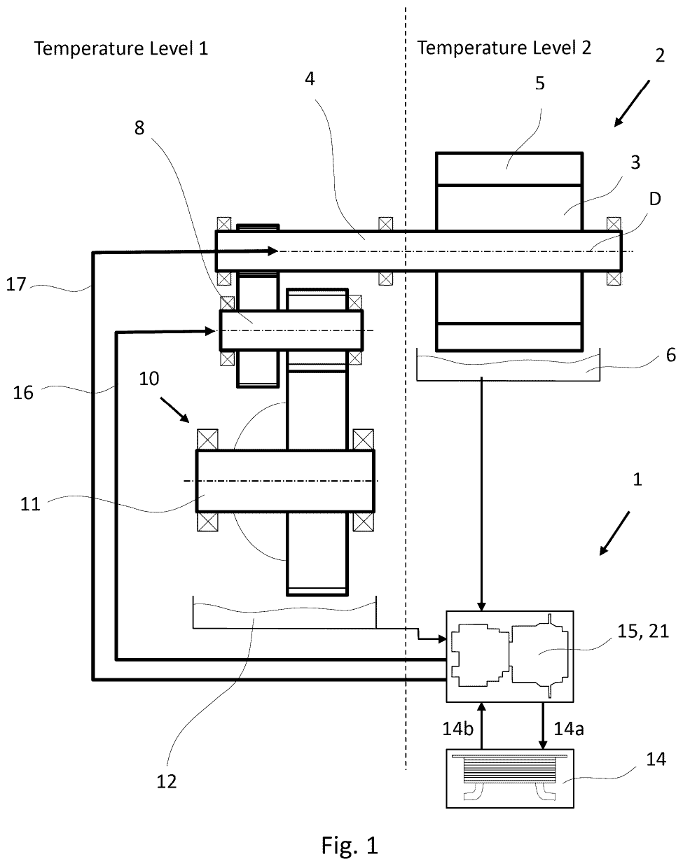

FIG. 1 shows a schematic representation of the cooling lubricant circuit of an arrangement 1 for the needs-based control of cooling/lubricating oil flows in an electric traction drive. The electric traction drive comprises, as components that are integrated into the cooling lubricant circuit and that need to be lubricated and/or cooled, an electric drive unit 2 and a gearbox 10. Oil as a hydraulic fluid is preferably used as the cooling lubricant.

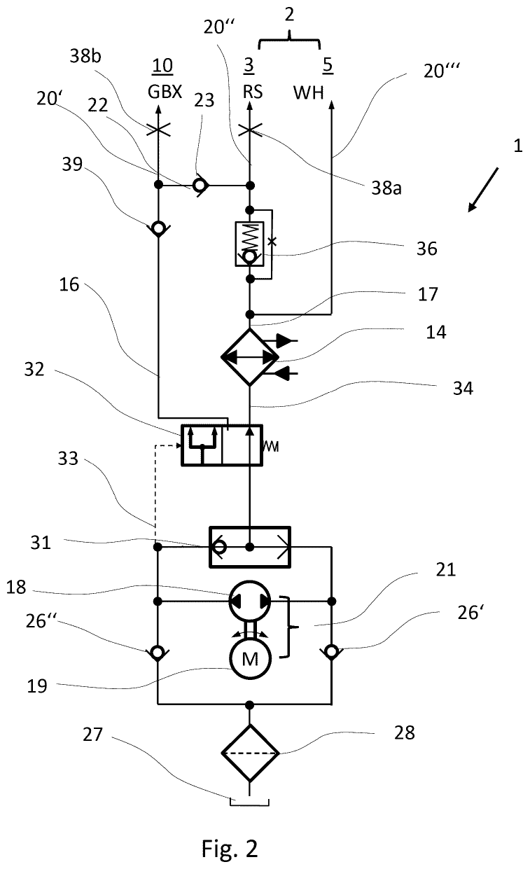

As can be seen from the representation, the cooling lubricant circuit has on the right-hand side a low temperature level (temperature level 2) on the side of the electric drive unit 2 and on the left-hand side a high temperature level (temperature level 1) on the side of the gearbox 10. The division into a low temperature level and a high temperature level is indicated by the vertical dashed line. In order to achieve these different fluid inflow temperatures, the arrangement 1 according to the invention can be used to adjust the corresponding fluid inflow temperatures by way of a first partial volume flow to the gearbox and by way of a second and third partial volume flow to the temperature-critical active components of the electric drive unit 2. This is described in more detail later on the basis of the hydraulic circuit diagrams in FIGS. 2-4 and 6-11.

The electric drive unit 2 has a rotor 3 with a rotor shaft 4, which rotates around its axis of rotation D in a stator 5. The stator 5 has in the usual manner a stator laminate package with stator windings that project axially beyond the stator laminate package on both end faces as so-called winding heads. The rotor 3 and stator 5 with winding heads form the aforementioned temperature-critical active components of the electric drive components, which can be cooled by the second and third partial volume flow. An oil sump 6 is assigned to the electric drive unit 2.

The rotor shaft 4 is coupled as an output shaft by way of a gear wheel pair with an intermediate shaft 8, and the intermediate shaft 8 is coupled by way of a further gear wheel pair with the gearbox 10, which is designed as a differential, in a drive-effective manner. The differential gearbox 10 has an output shaft 11. An oil sump 12 is assigned to the gearbox 10.

As can also be seen from FIG. 1, a heat exchanger 14 is connected on the low-temperature side, as are a hydraulic unit 15, which is in fluid communication with the heat exchanger by way of an inflow and outflow line 14a and 14b and comprises hydraulic valves, and a motor-pump unit 21.

A fluid line 16 to the gearbox 10 and a fluid line 17 to the electric drive unit 2 are provided starting from the hydraulic unit 15.

The fluid line 16 is assigned to the first partial volume flow 20′ at the high temperature level for cooling/lubricating the gearbox 10. The fluid line 17 is assigned to the second and third partial volume flows at the low temperature level. The division of the fluid line 17 into the second and third partial volume flows 20″ and 20′″ is not apparent from the illustration in FIG. 1. As described in more detail below, the second partial volume flow 20″ serves to lubricate and cool the rotor and the third partial volume flow 20′″ serves to lubricate and cool the winding heads of the stator 5.

FIG. 2 shows a hydraulic circuit diagram according to the arrangement 1 according to the invention for the needs-based control of partial volume flows 20′, 20″, 20′″ as well as the flow temperatures with the hydraulic unit 15, the motor-pump unit 21 as well as a heat exchanger 14 in a first embodiment.

The cooling lubricant pump 18 is driven by an electric motor 19 that can rotate in both directions. The two components form the electrically controllable motor-pump unit 21. The direction of rotation of the electric motor and the pump 18 in the clockwise direction (cw) is designated as direction of rotation A, the direction of rotation of the electric motor and the pump 18 in the counterclockwise direction (ccw) is designated as direction of rotation B.

The cooling lubricant pump 18 is connected to an oil sump 27 on the suction side and pressure side by way of a first non-return valve 26′ and a second non-return valve 26″. Depending on the direction of rotation of the pump, one of the two non-return valves 26′, 26″ is in an open position and the other is in a shut-off position. The connection to the oil sump 27 is made through a screen or filter element 28 arranged in between.

When the pump 18 is operated, the entire delivery volume flow supplied by the pump 18 is directed by way of a shuttle valve 31 and a hydraulically controllable switching valve 32 in the design of a spring-biased 3/2 directional control valve, which is adjustable by way of a pump pressure present in a control line 33. In the first position of the 3/2 directional control valve shown in FIG. 2, the entire delivery volume flow is supplied to the heat exchanger 14 by way of a fluid line 34. In a second position of the 3/2 directional control valve, the entire delivery volume flow is divided and a first portion is fed to the heat exchanger 14 by way of the fluid line 34, wherein after the oil has flowed through the heat exchanger 14, the portion of the delivery volume flow can be divided into the second and third partial volume flows 20″ and 20′″ between the rotor shaft RS and the stator winding heads WH. In the flow line of the 20″ partial volume flow to the rotor 3, a hydraulically controllable shut-off valve 36 is arranged with a bypass line 37 with an orifice, and in the inflow to the rotor 3 there is an orifice 38a which enables resistance control by way of a defined flow cross-section.

In the second position of the 3/2 directional control valve 32, the second part of the delivery volume flow is supplied as the first partial volume flow 20′ by way of the fluid line 16, in which a non-return valve 39 is installed, as well as an orifice 38b in the inflow to the gearbox GBX, 10.

A flow line 22 with a non-return valve 23 is provided between the inflow to the stator and the inflow to the gearbox. The non-return valve 23 blocks the direction of flow starting from the fluid line 16 to the inflow in the direction of the rotor 3.

The motor-pump unit 21 is controlled with regard to the direction of rotation and the pump pressure to be set by means of an electrical control unit, which is not shown, that is connected to a data bus. The control unit is connected to the motor 19 of the motor-pump unit 21 by way of an electrical line.

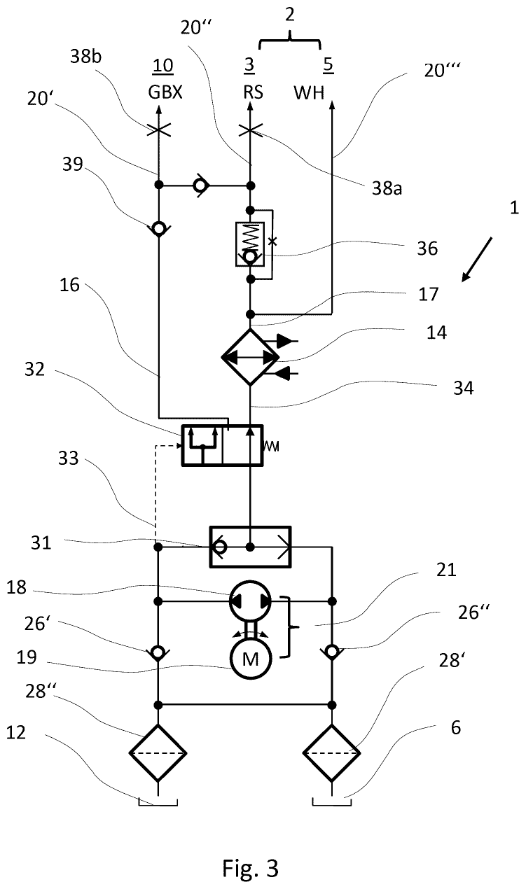

FIG. 3 shows a hydraulic circuit diagram of the arrangement 1 according to the invention for the needs-based control of partial volume flows 20′, 20″, 20′″ with a hydraulic unit 15 and a heat exchanger 14 in a second embodiment. In contrast to the embodiment described in FIG. 2, the oil sump 27 which has the filter element 28 and is common to both directions of rotation of the motor-pump unit 21 is replaced respectively by a separate oil sump 6, 12 with a filter element 28′, 28″, each arranged upstream of the suction side. Accordingly, the oil sump 12 is assigned to the gearbox GBX, 10 and the oil sump 6 is assigned to the electric drive unit 2, see FIG. 1.

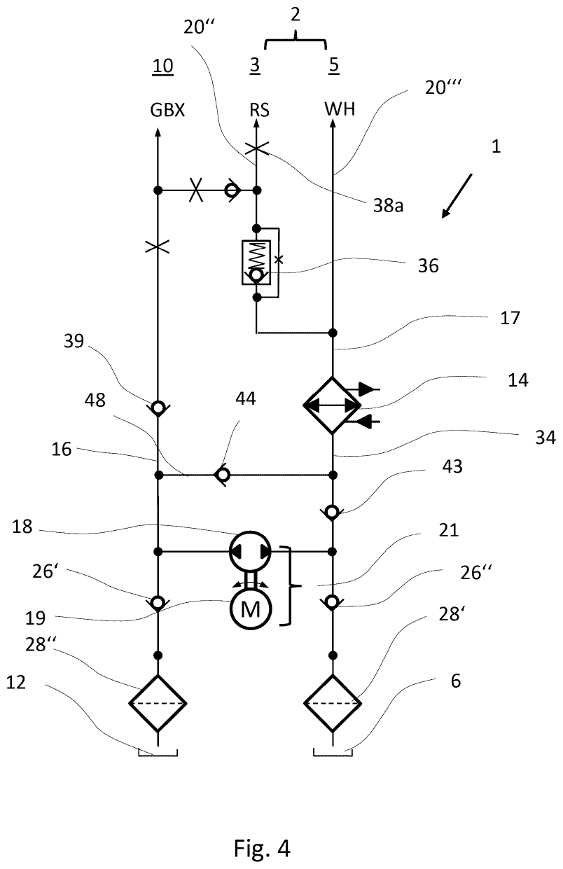

FIG. 4 shows a hydraulic circuit diagram of the arrangement 1 according to the invention for the needs-based control of partial volume flows 20′, 20″, 20′″ with a hydraulic unit 15 and a heat exchanger 14 in a third embodiment. In contrast to the second embodiment shown in FIG. 3, the shuttle valve 31 and the hydraulically controllable switching valve 32 arranged downstream in the flow path are not used. Instead of this, two further simple non-return valves 43, 44 are used in the hydraulic circuit diagram.

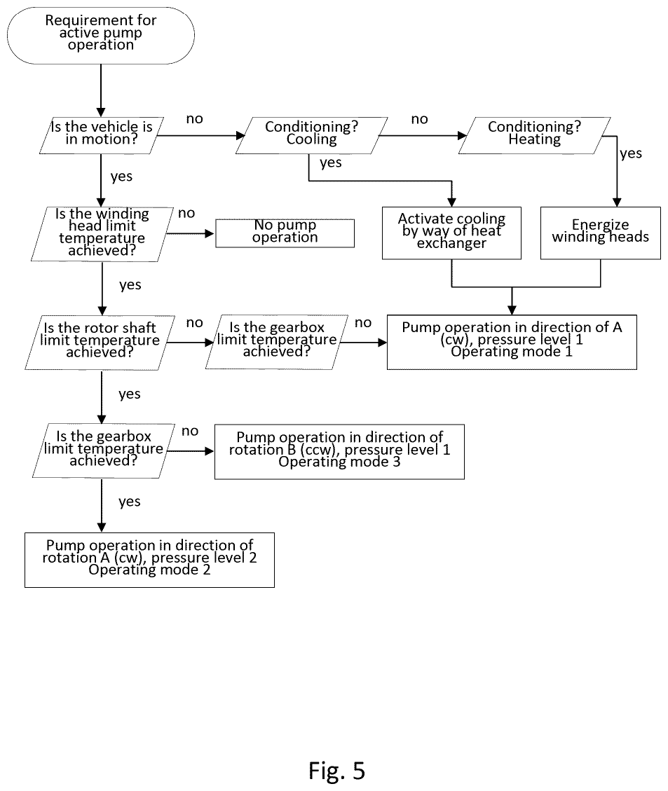

FIG. 5 shows an example of a method for the needs-based distribution of cooling/lubricating oil flows and for controlling the cooling oil flow temperatures of the partial volume flows in an electric traction drive with an arrangement according to the invention according to one of the preceding figures. This involves a query about a requirement for active pump operation, wherein active pump operation can be an operating mode in a first direction of rotation A or in a second direction of rotation B.

In the flow diagram, the first query is whether the vehicle is in motion. If the answer to this question is affirmative, the winding head limit temperature is checked.

If the winding head limit temperature is not reached, the query is terminated and no pumping operation is necessary.

If, however, in the case of this query the winding head limit temperature has been reached or exceeded, a query is made as to whether the rotor shaft limit temperature of the electrical machine has been reached. If this is not the case, a query is made as to whether the gearbox limit temperature has been reached. If this is not the case either, the pump is operated in direction of rotation A at pressure level 1 to achieve the first operating mode. If the limit temperatures (for the winding head and rotor shaft) have both been reached or exceeded, a query is made as to whether the gearbox limit temperature has been reached. If the gearbox limit temperature has been reached or exceeded, the pump operation in direction of rotation A at pressure level 2 is initiated to achieve the second operating mode.

However, if this query step determines that the gearbox limit temperature has not yet been reached, but the winding head and rotor shaft limit temperatures have been reached as described above, then pump operation in direction of rotation B at pressure level 1 is initiated to achieve the third operating mode.

If it is determined during the first query of the illustrated flow diagram that the vehicle is not in motion, then the choice is between active cooling and heating conditioning. If “cooling” is requested during the query, then the heat exchanger is activated to achieve the “cooling” conditioning. Furthermore, the pump operation is initiated in the direction of rotation A at pressure level 1 to achieve the first operating mode.

If cooling is not requested, “heating” is queried after conditioning. If this is requested, the winding heads are energized and the pump operation in direction of rotation A at pressure level 1 is initiated to achieve the first operating mode.

The third operating mode describes an optimized efficiency mode in which warm oil is present in the gearbox and cold oil is present for the stator windings of the electric machine and no oil is pumped into the rotor shaft of the electrical machine, thus eliminating splashing losses in the rotor shaft. By raising the temperature level in the gearbox with warm oil, the oil viscosity is reduced and thus the splashing losses and the losses of the gears are reduced.

For example, it can be measured that if the temperature in the gearbox is raised by 10° C., the energy required to operate the traction drive is reduced by ˜9 Wh.

In the second operating mode, the oil flow in the gearbox, in the rotor/stator and at the stator winding heads is cooled, thus achieving the maximum possible power of the electric traction drive. In this operating mode, the maximum speed and a uniformly large amount of energy can be converted.

In the first operating mode, only the stator winding heads are cooled, otherwise the gearbox is allowed to generate splash losses and rotor cooling is dispensed with. Moderate driving is possible, especially starting a vehicle.

The parameters for the closed-loop control and switching between the operating modes described above are oil temperature, pump power, power and/or the rotational speed of the electric motor.

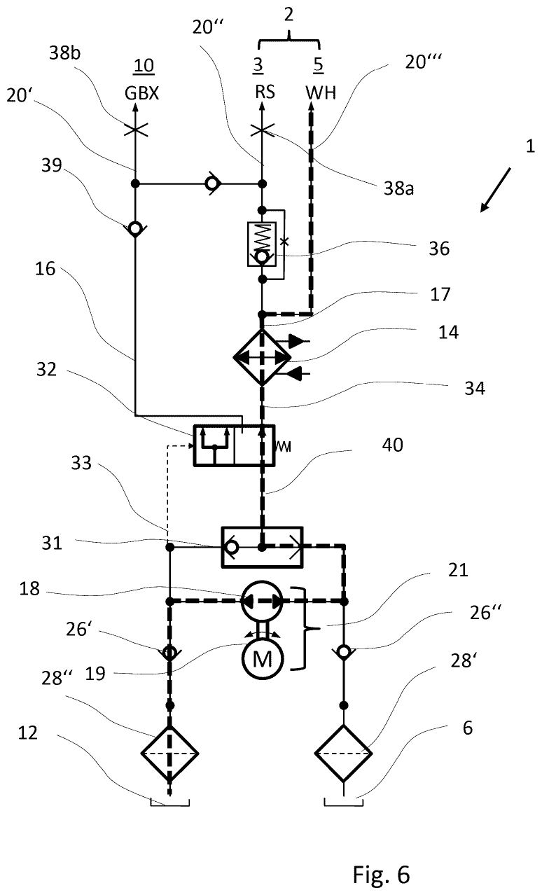

FIGS. 6, 7 and 8 show the operating modes that can be realized with the arrangement shown in FIG. 3.

In the first operating mode shown in FIG. 6, the volume flow 40 of the cooling lubricant (oil) starting from the oil sump 12 is shown by a dashed line. It can be seen that in the first operating mode, only the partial volume flow 20′″ is supplied to the stator 5, whereby active stator cooling takes place.

In the first operating mode, the pump 18 of the motor-pump unit 21 is operated at a pump rotational speed in the clockwise direction at a first pressure level (low pressure level), whereby the cooling lubricant is sucked in starting from the oil sump 12 and fed by way of the shuttle valve and the 3/2 directional control valve in the first position and the flow line 34 through the heat exchanger 14 and then directly to the stator. Due to the low pressure level in the flow lines, the hydraulically controllable shut-off valve 36 remains in the shut-off position. The rotor is therefore not cooled.

Cooling and lubrication in the gearbox GBX, 10 is implemented passively. Oil is conveyed as a cooling lubricant from the gear wheels of the gearbox by splashing into a reservoir and then distributed by way of channels in the gearbox.

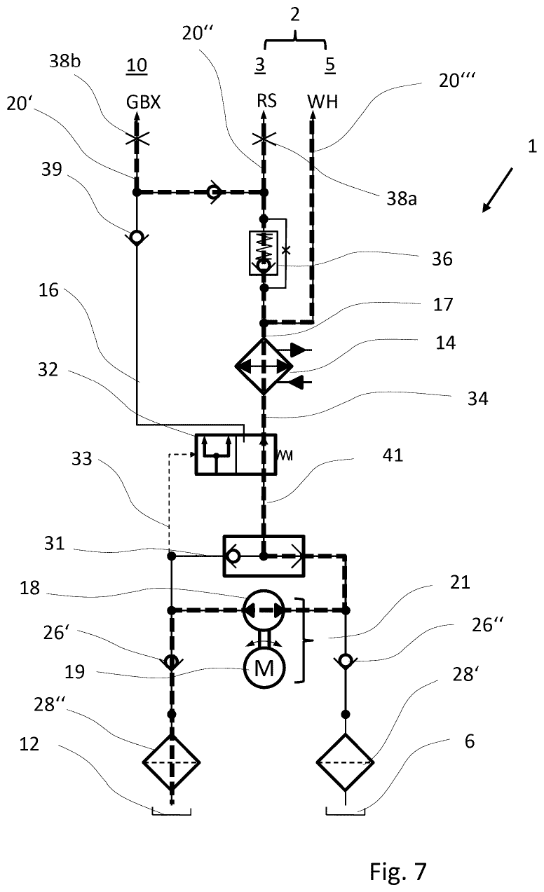

In the second operating mode shown in FIG. 7, the volume flow 41 of the cooling lubricant (oil) starting from the oil sump is shown by a dashed line. It can be seen that in the second operating mode, all partial volume flows 20′, 20″, 20′″ are supplied to the gearbox GBX, 10, the rotor 3 and the stator 5, whereby the temperature-critical active components stator 5 and rotor 3 are actively cooled. In addition, lubrication and cooling of the gearbox 10 are also actively implemented.

In the second operating mode, the pump 18 of the motor-pump unit 21 is operated at a pump rotational speed in the clockwise direction at a second pressure level (high pressure level), whereby the cooling lubricant (oil) is sucked in starting from the oil sump 12 and fed by way of the shuttle valve 31 and the 3/2 directional control valve 32 in the first position and the flow line 34 through the heat exchanger 14. Downstream of the heat exchanger 14, the volume flow 41 is divided into the three partial volume flows 20′, 20″, 20′″. Due to the high pressure level in the flow lines, the hydraulically controllable shut-off valve 36 is opened and a portion of the volume flow is supplied to the rotor by way of the orifice 38a and a portion of the volume flow is supplied to the gearbox 10 by way of the fluid line 22 and the non-return valve 23 and the orifice 38b. All partial volume flows have the same flow temperature in the second operating mode.

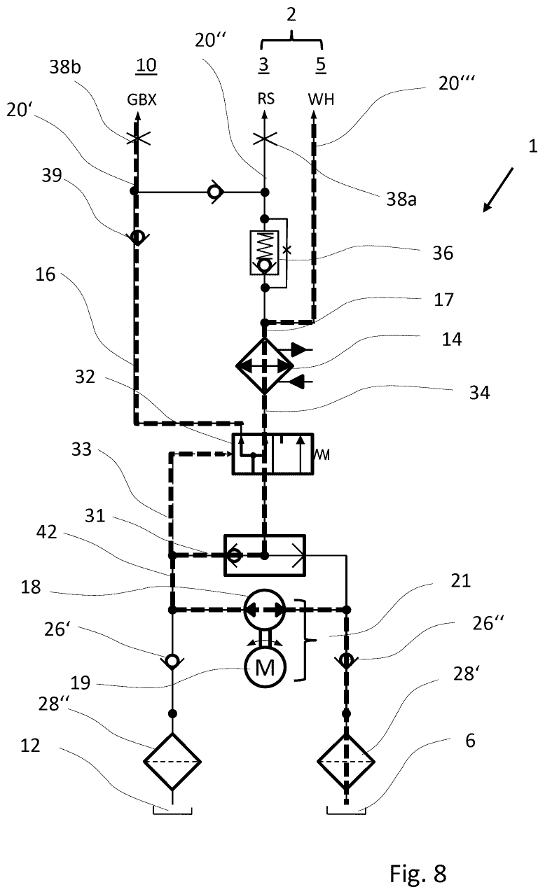

In the third operating mode shown in FIG. 8, the volume flow 42 of the cooling lubricant (oil) starting from the oil sump is shown by a dashed line. It can be seen that in the third operating mode, the partial volume flows 20′ and 20′″ are supplied to the gearbox GBX, 10 and the stator 5. The partial volume flows 20′ and 20′″ have a different flow temperature because the partial volume flow 20′ is not routed through the heat exchanger 14 for cooling.

Oil is actively conveyed to the gearbox 10 for lubrication, but it does not first pass through the heat exchanger 14. The stator 5 is actively cooled, but the rotor 3 is not cooled.

In the third operating mode, the pump 18 of the motor-pump unit 21 is operated at a pump rotational speed in the counterclockwise direction at a first pressure level (low pressure level), whereby the cooling lubricant (oil) is sucked in starting from the oil sump 6. However, the oil can also be sucked in from a connected oil sump 27, as shown in FIG. 2.

The oil is then routed by way of shuttle valve 31 in the second position and 3/2 directional control valve 32 in the second position. When the pump is operated at a pump rotational speed in the counterclockwise direction, the 3/2 directional control valve is adjusted to the second position by way of control line 33 and the applied pressure. In this second position of the 3/2 directional control valve 32, the volume flow 42 is divided into one portion which is routed by way of the flow line 34 through the heat exchanger 14 and then directly to the stator 5. Due to the low pressure level in the flow lines, the hydraulically controllable shut-off valve 36 remains in the shut-off position. Accordingly, the rotor 3 is not cooled.

A second portion of the volume flow 42 is conveyed directly into the fluid line 16 as a partial volume flow 20′ into the gearbox 10 by way of the 3/2 directional control valve. This portion of the volume flow does not pass through the heat exchanger 14, is not cooled and therefore has a higher flow temperature.

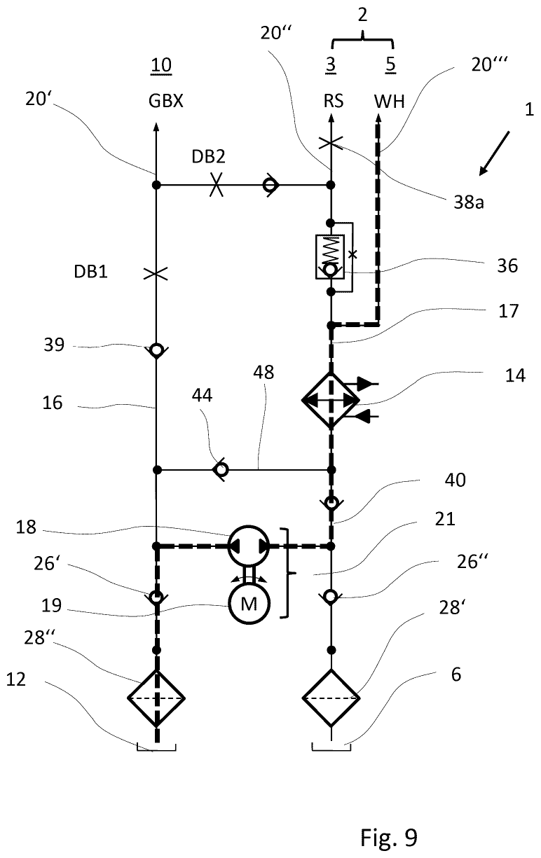

FIGS. 9, 10 and 11 show the operating modes that can be realized with the arrangement shown in FIG. 4.

With this arrangement and the corresponding method, the cooling lubricant can also either be fed through the heat exchanger or it is conveyed directly into the gearbox 10 or to the temperature-critical active components of the electrical machine 2. In contrast to the arrangement described above and the method according to the first and second embodiments, the three different operating modes are implemented by simple non-return valves 43, 44 and spring-loaded non-return valves 36. The shuttle valve 31 and the 3/2 directional control valve 32 are not required.

In the first operating mode shown in FIG. 9, the volume flow 40 of the cooling lubricant (oil) starting from the oil sump is shown by the dashed line. It can be seen that in the first operating mode, only the partial volume flow 20′″ is supplied to the stator 5, whereby active stator cooling takes place.

In the first operating mode, the pump 18 of the motor-pump unit 21 is operated at a pump rotational speed in the clockwise direction at a first pressure level (low pressure level), whereby the cooling lubricant is sucked in starting from the oil sump and fed by way of the flow line 34 through the heat exchanger 14 and then directly to the stator. Due to the low pressure level in the flow lines, the hydraulically controllable shut-off valve 36 remains in the shut-off position. The rotor is therefore not cooled.

The flow line 48 which is a connection between the flow line 34 and the fluid line 16 is blocked by way of the non-return valve 44 in the direction to the gearbox inflow.

Cooling and lubrication in the gearbox GBX, 10 is implemented passively. Oil is conveyed as a cooling lubricant from the gear wheels of the gearbox by splashing into a reservoir and then distributed by way of channels in the gearbox.

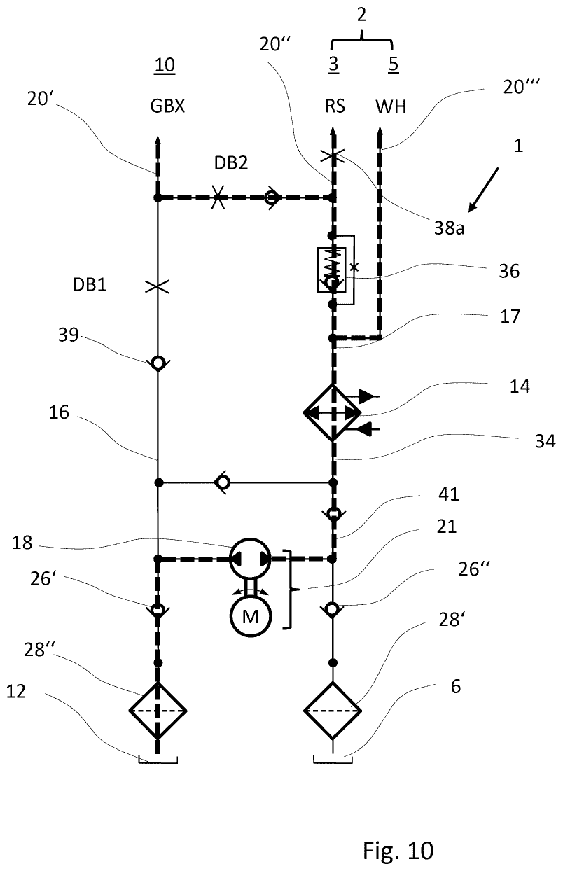

In the second operating mode shown in FIG. 10, the volume flow 41 of the cooling lubricant (oil) starting from the oil sump 12 is shown with a dashed line. It can be seen that in the second operating mode, all partial volume flows 20′, 20″, 20′″ to the gearbox GBX, 10, the rotor 3 and the stator 5 are provided, whereby the temperature-critical active components, stator and rotor, are actively cooled. In addition, the lubrication and cooling of the gearbox are also actively implemented.

In the second operating mode, the pump 18 of the motor-pump unit 21 is operated with a pump rotational speed in the clockwise direction at a second pressure level (high pressure level), whereby the cooling lubricant (oil) is sucked in starting from the oil sump 12 and fed by way of the flow line 34 through the heat exchanger 14. Downstream of the heat exchanger 14, the volume flow 41 is divided into the three partial volume flows 20′, 20″, 20′″. Due to the high pressure level in the flow lines, the hydraulically controllable shut-off valve 36 is opened and a portion of the volume flow is fed to the stator by way of the orifice 38a and a portion of the volume flow is fed to the gearbox by way of the shut-off valve and the orifice DB2. All partial volume flows have the same flow temperature in the second operating mode, which is necessary for cooling the components.

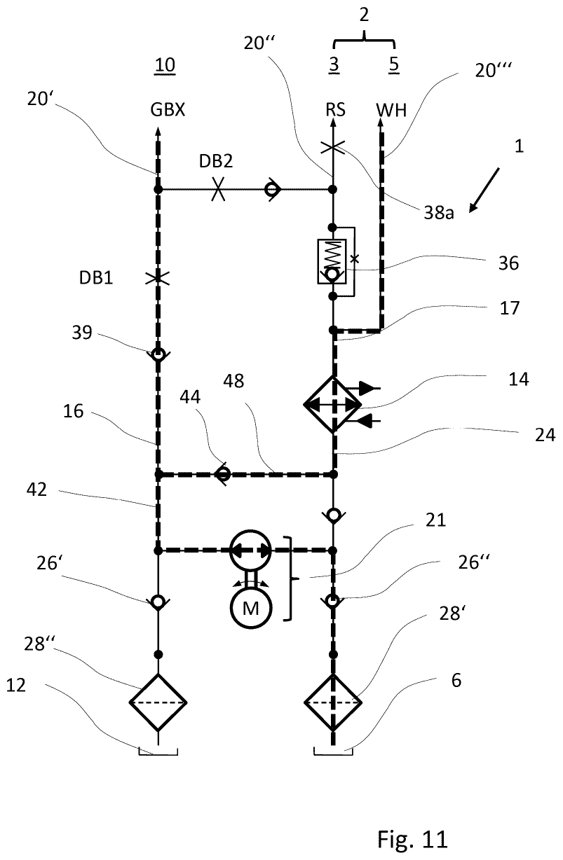

In the third operating mode shown in FIG. 11, the volume flow 42 of the cooling lubricant (oil) starting from the oil sump 6 is shown by a dashed line. It can be seen that in the third operating mode, the partial volume flows 20′ and 20′″ are supplied to the gearbox GBX, 10 and the stator 5. The partial volume flows 20′ and 20′″ have a different flow temperature because the partial volume flow 20′ is not routed through the heat exchanger 14 for cooling.

Oil is actively conveyed to the gearbox 10 for lubrication, but it does not first pass through the heat exchanger 14. The stator 5 is actively cooled, but the rotor 3 is not cooled.

In the third operating mode, the pump 18 of the motor-pump unit 21 is operated at a pump rotational speed in the counterclockwise direction at a first pressure level (low pressure level), whereby the cooling lubricant (oil) is sucked in starting from the oil sump 6. However, the oil can also be sucked in from a connected oil sump 27, as shown in FIG. 2.

The volume flow 42 is subsequently divided. A first portion is fed by way of the flow line 48 and the non-return valve 44 into the flow line 34 and then through the heat exchanger 14 and finally directly to the stator 5. Due to the low pressure level in the flow lines, the hydraulically controllable shut-off valve 36 remains in the shut-off position. Accordingly, the rotor 3 is not cooled.

A second portion of the volume flow 42 is conveyed directly into the fluid line 16 into the gearbox 10. This portion of the volume flow does not pass through the heat exchanger 14, is not cooled and therefore has a higher flow temperature.

What is claimed is:

1. An arrangement for the needs-based control of the flow temperatures of cooling/lubricating oil flows in an electric traction drive having an electrically controllable motor-pump unit and a hydraulic unit, wherein the motor-pump unit can be controlled in two directions of rotation, namely in a first direction of rotation and in a second direction of rotation which is opposite to the first direction of rotation, and wherein a first pressure level and a second pressure level, which is higher than the first pressure level, can be set at the motor-pump unit by closed-loop control of the rotational speed in the first direction of rotation or the second direction of rotation, and wherein the motor-pump unit is connected by way of the hydraulic unit to multiple fluid outlets for a first, a second and a third partial volume flow which are connected for cooling and/or heating and/or lubrication at least to the stator (5) of an electric drive unit, and/or the rotor of the electric drive unit and/or a gearbox, wherein the arrangement comprises a heat exchanger, and wherein the first partial volume flow is not connected to the heat exchanger, and wherein the direction of rotation and the pressure level of the motor-pump unit can be adjusted by means of an electric control unit and three different operating modes can be set depending on the direction of rotation and the pressure level, wherein the first partial volume flow is assigned to the inflow of the gearbox, the second partial volume flow is assigned to the inflow of the rotor and the third partial volume flow is assigned to the inflow of the stator, and wherein the hydraulic unit has a shuttle valve connected downstream in the flow path of the motor-pump unit and a downstream hydraulically controllable valve, preferably a 3/2 directional control valve, wherein the 3/2 directional control valve is adjustable from a first position into a second position by way of a control line and a control pressure, and wherein in the first position of the 3/2 directional control valve the volume flow is connected from the motor-pump unit by way of a fluid line to the heat exchanger and wherein the outlet of the heat exchanger is designed as a fluid line which branches into the second and third partial volume flows, wherein the third partial volume flow runs directly as an inflow to the stator and wherein the second partial volume flow is fed to the rotor by way of a hydraulically controllable non-return valve.

2. The arrangement as claimed in claim 1, wherein the first partial volume flow is formed by means of a fluid line in which a non-return valve and an orifice is arranged.

3. The arrangement as claimed in claim 1, wherein, in the first operating mode, the pump rotational speed of the motor-pump unit is operated in the first direction of rotation in the clockwise direction at a low pressure level and the entire volume flow flows by way of the shuttle valve and the 3/2 directional control valve in the first position, the fluid line and the heat exchanger for cooling and lubricating the stator as a third partial flow, and wherein the inflow to the rotor and the gearbox are blocked.

4. The arrangement as claimed in claim 1, wherein, in the second operating mode the pump rotational speed of the motor-pump unit is operated in the first direction of rotation in the clockwise direction at a high pressure level and the volume flow for actively cooling the gearbox, the rotor and the stator is conveyed to the heat exchanger by way of the 3/2 directional control valve in its first position and only downstream of the heat exchanger is a division performed into the first, second and third partial volume flows, wherein the non-return valve is in the open position due to the high pressure level, and downstream of the non-return valve, the volume flow is divided into the first and second partial volume flows by way of a fluid line.

5. The arrangement as claimed in claim 1, wherein, in the third operating mode the pump rotational speed of the motor-pump unit is operated in the second direction of rotation in the counterclockwise direction at a low pressure level and the entire volume flow flows by way of the shuttle valve and the 3/2 directional control valve in the second position and is divided into a first portion, which flows by way of the fluid line and the heat exchanger for cooling and lubrication of the stator as a third partial volume flow, wherein the inflow to the rotor is blocked, and a second portion, starting from the 3/2 directional control valve, is conveyed directly by way of the fluid line as a first partial volume flow with a high flow temperature to the gearbox for lubrication.

6. A method for the needs-based distribution and adjusting of flow temperatures of cooling/lubricating oil flows in an electric traction drive with the arrangement as claimed in claim 1, wherein three different operating modes can be set depending on the operation of the motor-pump unit in a first direction of rotation or an opposite second direction of rotation and the setting of the pressure level, wherein a first and/or a second and/or a third partial volume flow with the same or different flow temperatures can be set depending on the operating modes.

7. The method as claimed in claim 6, wherein the three operating modes represent an efficiency mode with optimized energy management, a maximum power mode and a moderate driving mode with reduced cooling of only the windings of the stator.

8. The method as claimed in claim 7, wherein the switching between the operating modes is performed on the basis of the parameters oil temperature, pump power, power and rotational speed of the electric motor.

9. The method as claimed in claim 6, wherein in the first operating mode, the pump rotational speed of the motor-pump unit is operated in the first direction of rotation in the clockwise direction at a low pressure level, whereby only active cooling of the stator is achieved by way of the third partial volume flow.

10. The method as claimed in claim 6, wherein, in the second operating mode, the pump rotational speed of the motor-pump unit is operated in the first direction of rotation in the clockwise direction at a high pressure level, whereby active cooling of the gearbox, the rotor and the stator is achieved by way of the first, second and third partial volume flows at the same flow temperatures.

11. The method as claimed in claim 6, wherein, in the third operating mode, the pump rotational speed of the motor-pump unit is operated in the second direction of rotation in the counterclockwise direction at a low pressure level, whereby active cooling of the stator is achieved by way of the third partial volume flow at a low flow temperature, and lubrication of the gearbox is achieved by way of the first partial volume flow at a higher flow temperature.
